(19) United States
(12) Patent Application Publication
(10) Pub. No.: US 2002/0064701 A1
(43) Pub. Date: May 30, 2002

(54) Conductive liquid crystalline polymer film and method of manufacture thereof

(76) Inventors: Doris I. Hand, Dayville, CT (US); William Richard Zdanis JR., Danielson, CT (US)

Correspondence Address: CANTOR COLBURN, LLP, 55 GRIFFIN ROAD SOUTH, BLOOMFIELD, CT, 06002

(21) Appl. No.: 09/950,557

(22) Filed: Sep. 11, 2001

Related U.S. Application Data
(60) Provisional application No. 60/231,912, filed on Sep. 11, 2000.

(51) Int. Cl. H01M 8/02; H01B 1/20

(52) U.S. Cl. 429/34; 252/500; 252/299.01; 428/1; 428/411.1

(57) ABSTRACT

A composite article comprises a porous, conductive layer disposed between a first liquid crystalline polymer layer and a second liquid crystalline polymer layer, wherein the porous conductive layer is impregnated with the first liquid crystalline polymer layer, the second liquid crystalline polymer layer or both liquid crystalline polymer layers. Each liquid crystalline polymer layers may be, independently, a single liquid crystalline polymer, a blend of liquid crystalline polymers, or a blend of non-liquid crystalline polymers and liquid crystalline polymers.

### CROSS REFERENCE TO RELATED APPLICATIONS

This application claims priority to U.S. Provisional Application Ser. No. 60/231,912 filed Sep. 11, 2000, which is herein incorporated by reference in its entirety.

### BACKGROUND OF THE INVENTION

1. Field of the Invention

This disclosure relates to liquid crystalline polymer composites, and in particular to conductive liquid crystalline polymer composites.

2. Description of the Related Art

Liquid crystalline polymers are a family of materials that exhibit a highly ordered structure in the melt, solution, and solid states. They can be broadly classified into two types: lyotropic, having liquid crystalline properties in the solution state, and thermotropic, having liquid crystalline properties in the melted state. Most liquid crystalline polymers exhibit excellent physical properties such as high strength, good heat resistance, low coefficient of thermal expansion, good electrical insulation characteristics, low moisture absorption, good chemical resistance, and are good barriers to gas flow. Such properties make them useful, in sheet form, as substrate materials for printed circuit boards, packaging, and other high-density applications.

There has been considerable interest in making conductive liquid crystalline polymer materials. For example, U.S. Pat. No. 4,772,422 teaches a conductive liquid crystalline polymer composition comprising liquid crystalline polymer and electrically conductive carbon black. U.S. Pat. No. 5,164,458 discloses a blend of liquid crystalline polymer and a polymeric, polyvalent, metal aromatic polycarboxylate that can optionally contain fillers, fibers and mineral reinforcing agents. U.S. Pat. No. 5,882,570 teaches grinding graphite and mixing it with a liquid crystalline polymer resin. Thus, the approach to date has consistently been to mix the conductive filler throughout the liquid crystalline resin.

This approach has drawbacks, especially when the resultant materials are used to make bipolar plates in fuels cells. Bipolar plates require a fairly high level of conductivity, which in turn requires a large amount of conductive filler. Large amounts of filler are difficult to incorporate into resin compositions, and result in an increase in the weight of the product material. Ideal materials for use in vehicular fuel cells are lightweight in order to obtain optimum vehicle efficiency.

Another drawback relates specifically to use in corrosive environments, for example a fuel cell environment. In such environments, the exterior faces of the bipolar plates, which confront adjacent cells, are in constant contact with often highly corrosive, acidic or basic solutions at elevated temperatures. Moreover, the cathode face of the bipolar plate is polarized in the presence of pressurized, saturated air and the anode face of the bipolar plate is exposed to pressurized, saturated hydrogen. Byproducts of corrosion and degradation can poison the fuel cell and decrease or even halt fuel cell operation. When conductive fillers are dispersed throughout the liquid crystalline polymer, and throughout the resulting bipolar plate, at least some are on or close to the surface of the bipolar plate, possibly causing poisoning of the fuel cell.

Accordingly, there is a need in the art for conductive, liquid crystalline polymer materials, which are lightweight and highly chemically resistant, particularly in the environment of fuel cells.

### SUMMARY OF THE INVENTION

The above discussed and other drawbacks and deficiencies in the art are overcome or alleviated by a composite article comprising a porous, conductive layer disposed between a first liquid crystalline polymer layer and a second liquid crystalline polymer layer, wherein the porous, conductive layer is impregnated with the first liquid crystalline polymer layer, the second liquid crystalline polymer layer or both liquid crystalline polymer layers. The liquid crystalline polymer used for each liquid crystalline polymer layers may be, independently, a single liquid crystalline polymer, a blend of liquid crystalline polymers, or a blend of non-liquid crystalline polymers and liquid crystalline polymers.

In one method manufacture of the composite article, a porous, conductive layer is disposed between two liquid crystalline layers, followed by lamination or other process to impregnate the porous layer.

In another method of manufacture, particulate conductive material is applied to a first liquid crystalline layer to form a porous, conductive layer on the first liquid crystalline polymer layer, and a second liquid crystalline is disposed on the porous, conductive layer, followed by lamination or other process to impregnate the porous, conductive layer.

The composite articles are lightweight, conductive, and useful in the formation of bipolar plates for fuel cells. Relatively high levels of conductivity may be achieved without the need to incorporate large quantities of conductive filler into a resin. These and other features and advantages will be appreciated and understood by those skilled in the art from the following detailed description.

### BRIEF DESCRIPTION OF THE FIGURES

Referring now to the exemplary drawings wherein like elements are numbered alike in the several FIGURES:

FIG. 1 shows a two layer composite article.

FIG. 2 shows a three layer composite article.

FIG. 3 shows a multi-layer composite article.

### DETAILED DESCRIPTION OF THE PREFERRED EMBODIMENTS

A composite article that finds particular utility as a bipolar plate for fuel cells comprises a porous, conductive layer impregnated with a liquid crystalline polymer. The composite article typically comprises a porous conductive layer disposed between a first liquid crystalline polymer layer and a second liquid crystalline polymer layer, wherein the porous, conductive layer is impregnated with the first liquid crystalline polymer layer, the second liquid crystalline polymer layer or both. Preferably, the liquid crystalline polymer fills the pores of the porous, conductive layer, and completely surrounds the porous, conductive layer.

Liquid crystalline polymers are known polymers, and are sometimes described as “rigid-rod”, “rod-like”, or ordered polymers. These polymers are believed to have a fixed molecular shape, e.g. linear, or the like, due to the nature of the repeating units comprising the polymeric chain. The repeating units typically comprise rigid molecular elements. The rigid molecular elements (mesogens) are frequently rod-like or disk-like in shape and are typically aromatic and frequently heterocyclic. The rigid molecular elements may be present in either the main chain (backbone) of the polymer or in the side chains. When present in the main chain or in the side chains they may be separated by more flexible molecular elements, sometimes referred to as spacers.

Liquid crystalline polymers can be blended with polymers that are not liquid crystalline polymers, hereinafter referred to as non-liquid crystalline polymers. These blends are sometimes referred to as polymer alloys. Some of these blends have processing and functional characteristics similar to liquid crystalline polymers and are thus included within the scope of the present invention. The non-liquid crystalline polymers and liquid crystalline polymer components are generally mixed in a weight ratio of 10:90 to 90:10, preferably in the range of 30:70 to 70:30. Hereinafter the term liquid crystalline polymer will include liquid crystal polymer blends.

Both thermotropic and lyotropic liquid crystalline polymers are useful. Furthermore, useful liquid crystalline polymers can be thermoplastic or thermosetting. Suitable thermotropic liquid crystalline polymers include liquid crystal polyesters, liquid crystal polycarbonates, liquid crystal polyetheretherketone, liquid crystal polyetherketoneketone and liquid crystal polyester imides, specific examples of which include (wholly) aromatic polyesters, polyester amides, polyamide imides, polyester carbonates, and polyazomethines.

Useful thermotropic liquid crystalline polymers also include polymers comprising a segment of a polymer capable of forming an anisotropic molten phase as part of one polymer chain thereof and a segment of a polymer incapable of forming an anisotropic molten phase as the rest of the polymer chain, and also a composite of a plurality of thermotropic liquid crystalline polymers.

Representative examples of the monomers usable for the formation of the thermotropic liquid crystalline polymer include:

(a) at least one aromatic dicarboxylic acid compound,

(b) at least one aromatic hydroxy carboxylic acid compound,

(c) at least one aromatic diol compound,

(d) at least one of an aromatic dithiol (d₁), an aromatic thiophenol (d₂), and an aromatic thiol carboxylic acid compound (d₃), and

(e) at least one of an aromatic hydroxyamine compound and an aromatic diamine compound.

They may sometimes be used alone, but may frequently be used in a combination of monomers (a) and (c); (a) and (d); (a), (b) and (c); (a), (b) and (e); (a), (b), (c) and (e); or the like.

Examples of the aromatic dicarboxylic acid compound (a) include aromatic dicarboxylic acids such as terephthalic acid, 4,4′-diphenyldicarboxylic acid, 4,4′-triphenyldicarboxylic acid, 2,6-naphthalenedicarboxylic acid, 1,4-naphthalenedicarboxylic acid, 2,7-naphthalenedicarboxylic acid, diphenyl ether-4,4′-dicarboxylic acid, diphenoxyethane-4,4′-dicarboxylic acid, diphenoxybutane-4,4′-dicarboxylic acid, diphenylethane-4,4′-dicarboxylic acid, isophthalic acid, diphenyl ether-3,3′-dicarboxylic acid, diphenoxyethane-3,3′-dicarboxylic acid, diphenylethane-3,3′-dicarboxylic acid, and 1,6-naphthalenedicarboxylic acid; and alkyl-, alkoxy- and halogen-substituted derivatives of the above-mentioned aromatic dicarboxylic acids, such as chloroterephthalic acid, dichloroterephthalic acid, bromoterephthalic acid, methylterephthalic acid, dimethylterephthalic acid, ethylterephthalic acid, methoxyterephthalic acid, and ethoxyterephthalic acid.

Examples of the aromatic hydroxy carboxylic acid compound (b) include aromatic hydroxy carboxylic acids such as 4-hydroxybenzoic acid, 3-hydroxybenzoic acid, 6-hydroxy-2-naphthoic acid, and 6-hydroxy-1-naphthoic acid; and alkyl-, alkoxy- and halogen-substituted derivatives of the aromatic hydroxy carboxylic acids, such as 3-methyl-4-hydroxybenzoic acid, 3,5-dimethyl-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2,5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, and 6-hydroxy-5,7-dichloro-2-naphthoic acid.

Examples of the aromatic diol compound (c) include aromatic diols such as 4,4′-dihydroxydiphenyl, 3,3′-dihydroxydiphenyl, 4,4′-dihydroxytriphenyl, hydroquinone, resorcinol, 2,6-naphthalenediol, 4,4′-dihydroxydiphenyl ether, bis(4-hydroxyphenoxy)ethane, 3,3′-dihydroxydiphenyl ether, 1,6-naphthalenediol, 2,2-bis(4-hydroxyphenyl)propane, and bis(4-hydroxyphenyl)methane; and alkyl-, alkoxy- and halogen-substituted derivatives of the aromatic diols, such as chlorohydroquinone, methylhydroquinone, t-butylhydroquinone, phenylhydroquinone, methoxyhydroquinone, phenoxyhydroquinone, 4-chlororesorcinol, and 4-methylresorcinol.

Examples of the aromatic dithiol (d₁) include benzene-1,4-dithiol, benzene-1,3-dithiol, 2,6-naphthalene-dithiol, and 2,7-naphthalene-dithiol.

Examples of the aromatic thiophenol (d₂) include 4-mercaptophenol, 3-mercaptophenol, and 6-mercapto-phenol.

Examples of the aromatic thiol carboxylic acid (d₃) include 4-mercaptobenzoic acid, 3-mercaptobenzoic acid, 6-mercapto-2-naphthoic acid, and 7-mercapto-2-naphthoic acid.

Examples of the aromatic hydroxyamine compound and the aromatic diamine compound (e) include 4-aminophenol, N-methyl-4-aminophenol, 1,4-phenylenediamine, N-methyl-1,4-phenylenediamine, N,N′-dimethyl-1,4-phenylenediamine, 3-aminophenol, 3-methyl-4-aminophenol, 2-chloro-4-aminophenol, 4-amino-1-naphthol, 4-amino-4′-hydroxydiphenyl, 4-amino-4′-hydroxydiphenyl ether, 4-amino-4′-hydroxydiphenylmethane, 4-amino-4′-hydroxydiphenyl sulfide, 4,4′-diaminodiphenyl sulfide (thiodianiline), 4,4′-diaminodiphenyl sulfone, 2,5-diaminotoluene, 4,4′-ethylenedianiline, 4,4′-diaminodiphenoxyethane, 4,4′-diaminodiphenylmethane (methylenedianiline), and 4,4′-diaminodiphenyl ether (oxydianiline).

Thermotropic liquid crystalline polymers are prepared from monomer(s) as mentioned above by a variety of esterification methods such as melt acidolysis or slurry polymerization, or the like methods.

The molecular weight of the thermotropic liquid crystalline polyester that may favorably be used may be about 2,000 to 200,000, preferably 4,000 to 100,000. The measurement of the molecular weight may be done, for example, either through determination of the terminal groups of a compressed film thereof according to infrared spectroscopy, or by gel permeation chromatography (GPC).

Thermotropic liquid crystalline polymers may be used either alone or in mixture of at least two thereof. A preferred thermotropic liquid crystalline polymer is 2-naphthalene carboxylic acid, 6-(acetyloxy)-polymer with 4-(acetyloxy) benzoic acid.

Suitable lyotropic liquid crystalline polymers include concentrated sulfuric acid solutions of poly(p-phenylene terephthalamide) (PPTA), silk fibroin aqueous solutions, and sericin aqueous solutions. A PPTA liquid crystalline polymer is represented by

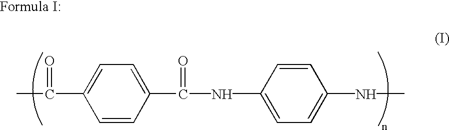

Possible liquid crystalline polymers which can be used with the present invention include, but are not limited to VECTRA®, commercially available from Ticona, XYDAR®, commercially available from Amoco Polymers, and ZENITE®, commercially available from DuPont, among others. An especially preferred liquid crystalline polymer film is based on copolymer of hydroxy benzoate/hydroxy naphthoate, known commercially as VECSTAR®, available from Kuraray Co., Ltd., Japan. The liquid crystalline polymers and polymer blends described hereinabove are meant for illustration and not for limitation, as many other suitable liquid crystalline polymers and polymer blends are known in the art. Likewise, it is recognized that compatibilizers, plasticizers, flame retardant agents, and other additives may be contained in the liquid crystalline polymers.

In the manufacture of bipolar plates for fuel cells, the liquid crystalline polymers are useful in sheet or film form. Useful thicknesses are about 10 to about 60 mils (about 254 to about 1524 micrometers), with from about 20 to about 40 mils (about 508 to about 1016 micrometers) preferred and about 30 mils (about 762 micrometers) especially preferred.

Useful conductive materials include but are not limited to graphite, and metals such as copper, iron, steels such as stainless steel, nickel, and their alloys. Stainless steel is preferred.

In one embodiment, a porous, conductive layer is pre-formed and then impregnated with liquid crystalline polymer. The porous, conductive layer may be provided in a variety of forms, most usefully in the form of a porous, conductive sheet, for example a woven or non-woven mat of conductive fibers or a porous mass of sintered particles. The shape of the porous, conductive layer, particularly the thickness of a sheet, is determined by the particular use, i.e., by the size of the fuel cell in the case of a bipolar plate. A useful thickness is about 0.05 to about 100 mils (about 1.3 to about 2540 micrometers), preferably about 0.05 to about 30 mils (about 1.3 to about 762 micrometers), most preferably about 3 to about 20 mils (about 76 to about 508 micrometers). The density of the sheet (i.e., the degree of porosity) is also determined by the end use, and particularly upon the desired degree of conductivity. Useful porosities are in the range from about 50 to about 90 volume percent, preferably about 70 to about 90 volume percent.

In manufacture, a first liquid crystalline polymer layer is disposed on a first side of the porous, conductive layer, and a second liquid crystalline polymer layer on the opposite side of the conductive layer. The first and second liquid crystalline polymer layers may comprise the same or different liquid crystalline polymer. If different liquid crystalline polymers are used then it is preferable for them to be chosen so as to be compatible, i.e., to have matched mechanical and/or rheological properties. The three layers may then be adhered by application of heat and pressure (laminated). Alternatively, or in addition, an adhesive may be used between one or more of the layers. Known lamination methods may be used, for example roll-to-roll lamination or press lamination. Lamination temperatures and pressures are selected to fixedly attach the layers together, wherein the temperature employed is typically less than the temperature at which the liquid crystalline polymer layers and the conductive layer suffer from deterioration. Alternatively, a liquid crystalline polymer layer and a layer of porous, conductive material may be laminated or adhered to form a two-layer material.

In another method of manufacture, particulate conductive material is applied to a first liquid crystalline layer to form a porous, conductive layer on the first liquid crystalline polymer layer, and a second liquid crystalline layer is optionally disposed on the porous, conductive layer, followed by lamination or other process to impregnate the porous, conductive layer. In this embodiment, the particles may have an average size of about 0.05 to about 60 micrometers. The particles may be applied to the liquid crystalline polymer layer by methods known in the art, including electrospray deposition, spray coating, and roll coating (similar to adhesive manufacturing). The thickness, amount, and distribution of the conductive particulate material are dependent upon the desired porosity, which is determined by the end use of the composite article.

In either method of manufacture, the conductivity of the composite article can be adjusted by the type, amount, and porosity of the conductive material. Conductivities, often expressed as volume resistivity, may be measured according to IPC TM-650. Volume resistivities of about 0.005 ohm-cm to about 0.600 ohm-cm, preferably about 0.005 ohm-cm to about 0.030 ohm-cm may be achieved. Alternatively, it may be desired to only have conductivity over one half of the surface area, or only around the perimeter. This could easily be achieved by locating the conductive material appropriately.

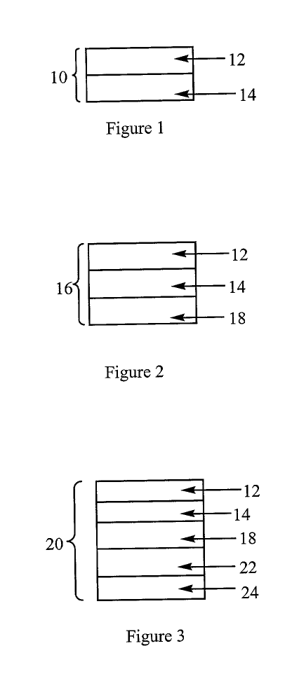

Turning now to the Figures, FIG. 1 shows a composite article 10 comprising a liquid crystalline polymer layer 12 laminated to a porous, conductive layer 14 to form a two layer composite article. FIG. 2 shows composite article 16 comprising a porous, conductive layer 14 disposed between a first liquid crystalline polymer layer 12 and a second liquid crystalline polymer layer 18. When the composite article comprises three or more layers the layers may be laminated or adhered at the same time or in a stepwise fashion.

FIG. 3 shows a multi-layer composite article 20 comprising a first liquid crystalline polymer layer 12 disposed on a first porous, conductive layer 14, disposed on a second liquid crystalline polymer layer 18, which is disposed on a second, porous conductive layer 22, which is disposed on a third liquid crystalline polymer layer 24. Composite article 20 may be formed for example, by laminating two layer composite article 10 to three layer composite article 16.

The composite film articles described may be used to form cooling fields, manifolds, heating channels, bipolar plates used in fuel cells, and the like.

There are a variety of fuel cell types but a preferred type of fuel cell is the “proton exchange membrane” cell, wherein the cathode of the cell is separated from the anode by a proton exchange membrane that facilitates the diffusion of ions and/or water between the cathode and anode. The cathode, proton exchange membrane and anode may be collectively referred to as the membrane electrode assembly (MEA). The MEA for each cell is placed between a pair of electrically conductive elements which serve as current collectors for the anode/cathode, and which generally contain an array of grooves in the faces thereof for distributing the gaseous reactants (H₂ and O₂/air) over the surfaces of the anode and cathode. The typical fuel cell includes a number of individual cells arranged in a stack, with the working fluid directed through the cells via input and output conduits formed within the stack structure. The individual cells may be stacked together in electrical series, which are separated from each other by an impermeable, electrically conductive plate referred to as a bipolar plate. The bipolar plate generally also has reactant gas distributing grooves on both external faces thereof, as well as internal passages through which coolant flows to remove heat from the stack.

The invention is further illustrated by the following non-limiting Example, wherein a liquid crystalline polymer film, FA-X100 available from Kuraray, with a thickness of 1.0 mil (about 25 micrometers) was placed on opposite sides of a stainless steel sintered pad, approximately 7.3 mil (185 micrometers) thick, made from 8 micrometer stainless steel fibers of 225 grams per square meter. The porosity of the pad was 80%. The two layers of liquid crystalline polymer film and stainless steel sintered pad was laminated by raising the temperature from room temperature to 500° F. at 8° F. per minute while maintaining a pressure of 100 pounds per square inch (psi). The temperature was then raised to 570° F. at 4° F. per minute and held at 570° F. while maintaining a pressure of 425 psi. The temperature was then decreased to 200° F. at a rate of 10° F. per minute while maintaining a pressure of 425 psi. The final thickness of the composite film was approximately 6 mils.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A composite article comprising a porous, conductive layer disposed between a first liquid crystalline polymer layer and a second liquid crystalline polymer layer, wherein the porous, conductive layer is impregnated with the first liquid crystalline polymer layer, the second liquid crystalline polymer layer or both liquid crystalline polymer layers.

2. The article of claim 1, wherein at least one liquid crystalline polymer layer is thermotropic.

3. The article of claim 1, wherein the liquid crystalline polymer of at least one of the liquid crystalline polymer layers is a blend of two or more liquid crystalline polymers or a blend of at least one liquid crystalline polymer and at least one non-liquid crystalline polymer.

4. The article of claim 1, wherein the porous, conductive layer comprises sintered particles, a woven mat, or a non-woven mat.

5. The article of claim 1, wherein the porous, conductive layer is a stainless steel sintered pad.

6. The article of claim 1, wherein the liquid crystalline polymer of at least one of the liquid crystalline polymer layers is a copolymer of hydroxy benzoate/hydroxy napthoate.

7. A method of forming a composite article comprising
disposing a first liquid crystalline polymer layer on a first side of a porous conductive layer, and a second liquid crystalline polymer layer on the opposite side of the porous conductive layer; and
impregnating the porous, conductive layer with the liquid crystalline polymer layers.

8. The method of claim 7, wherein at least one liquid crystalline polymer layer is thermotropic.

9. The method of claim 7, wherein the liquid crystalline polymer of at least one of the liquid crystalline polymer layers is a blend of two or more liquid crystalline polymers or a blend of at least one liquid crystalline polymer and at least one non-liquid crystalline polymer.

10. The method of claim 7, wherein the porous, conductive layer comprises sintered particles, a woven mat, or a non-woven mat.

11. The method of claim 7, wherein the porous, conductive layer is a stainless steel sintered pad.

12. The method of claim 7, wherein impregnating is performed by laminating.

13. The method of claim 7, wherein the liquid crystalline polymer of at least one of the liquid crystalline polymer layer is a copolymer of hydroxy benzoate/hydroxy napthoate.

14. A method of forming a composite article comprising
applying particulate, conductive material to a first liquid crystalline layer to form a porous, conductive layer;
disposing a second liquid crystalline layer on the porous, conductive layer; and
impregnating the porous, conductive layer with the liquid crystalline polymer layers.

15. The method of claim 14, wherein at least one liquid crystalline polymer layer is thermotropic.

16. The method of claim 14, wherein the liquid crystalline polymer of at least one of the liquid crystalline polymer layers is a blend of two or more liquid crystalline polymers or a blend of at least one liquid crystalline polymer and at least one non-liquid crystalline polymer.

17. The method of claim 14, wherein impregnating is performed by laminating.

18. A bipolar plate comprising a porous, conductive layer disposed between a first liquid crystalline polymer layer and a second liquid crystalline polymer layer, wherein the porous, conductive layer is impregnated with the first liquid crystalline polymer layer, the second liquid crystalline polymer layer or both liquid crystalline polymer layers.

19. A fuel cell comprising a bipolar plate, wherein the bipolar plate comprises a porous, conductive layer disposed between a first liquid crystalline polymer layer and a second liquid crystalline polymer layer, wherein the porous, conductive layer is impregnated with the first liquid crystalline polymer layer, the second liquid crystalline polymer layer or both liquid crystalline polymer layers.
